(19) United States
(12) Patent Application Publication
(10) Pub. No.: US 2026/0297721 A1
(43) Pub. Date: Oct. 1, 2026

(54) Component and Method for Producing a Component That Has a Surface With an Increased Torsional Moment

(71) Applicant: Bayerische Motoren Werke Aktiengesellschaft, Muenchen (DE)

(72) Inventors: Daniele GAROFALO, Muenchen (DE); Uwe KIRSCHNER, Muenchen (DE); Joachim MEESS, Ergoldsbach (DE); Udo REILAENDER, Muenchen (DE)

(21) Appl. No.: 18/874,218

(22) PCT Filed: Jul. 5, 2023
(86) PCT No.: PCT/EP2023/068545

§ 371 Date: Dec. 12, 2024

(30) Foreign Application Priority Data
Aug. 2, 2022 (DE) 10 2022 119 294.6

(51) Int. Cl. C23C 4/12; C23C 4/08

(52) U.S. Cl. CPC C23C 4/12; C23C 4/08

(57) ABSTRACT

A component has a fastening region with a fastening surface that is coated. The coating is produced by a thermal spraying process, and the coating has undulations along a first direction.

### BACKGROUND AND SUMMARY

The present invention relates to a component and to a method for producing a component.

Components of the type in question have fastening faces, such as screw-connection faces, for fastening to other components or component parts. This is for example to ensure that a certain torsional moment of friction can be transmitted.

In this context, DE 10 2008 017 029 A1 proposes a friction-increasing layer on a component, obtainable by hard material particles being thrown onto a surface serving as connection face of the component, in such a way that the hard material particles are introduced into the connection face of the component, but protrude therefrom, either the entire surface or only parts of the surface of the hard material particles making materially integral contact with the material of the component, and the connection face of the component being covered incompletely, in particular ≤30%, with hard material particles. The hard material particles are thrown on in particular by way of a thermal spraying method. It has been shown that there is still a lot of potential for improvement particularly when using thermal spraying methods to generate such layers or coatings.

It is therefore an object of the present invention to provide a component and a method for producing a component, it being intended to further optimize layers produced in particular by means of thermal spraying methods, such as in particular friction-increasing adhesion layers.

This object is achieved by means of a component and by means of a method according to the independent claim(s). Further advantages and features will be apparent from the dependent claims and from the description and the attached figures.

According to the invention, a component comprises a fastening region with a fastening face which has a coating, wherein the coating is generated or formed by a thermal spraying method, and wherein the coating has a corrugation in a first direction. It has surprisingly been shown that a coating having a corrugated (undulated), that is to say non-smooth, surface is very well suited for example for transmitting higher torsional moments than a flat or smooth surface (with the same roughness). According to a preferred embodiment, the aforementioned fastening face is for example a screw-connection face, expediently a flat or planar face. However, expediently, the coating or the surface thereof which is generated thereon is not flat, but rather has the corrugation.

Components of the type in question are for example components composed of metallic materials, such as light metal materials, such as aluminum, or steel. According to one embodiment, the component is for example a component which is used in the motor vehicle sector, for example a chassis or body component part, a structural component, a component of the drivetrain, such as a transmission bearing etc. Preferred motor vehicles are in particular passenger cars, utility vehicles or alternatively motorcycles, that is to say in particular land vehicles.

According to one embodiment, the corrugation is formed by an in particular recurring succession of troughs and crests. Here, the expression “corrugation” should not necessarily be understood as meaning that a curved profile is formed in the first direction. The corrugation can for example also be formed in a “stepped” manner. However, it is crucial that there is a succession of depressions and elevations. In particular, this for example makes it possible to ensure that the surface pressure is increased regionally, as a result of which a coating, in particular an adhesion layer, can be generated which is for example suitable for transmitting high and ultra-high torsional moments.

According to one embodiment, the geometry generated during the coating is or has been mechanically reworked. This for example makes it possible to form the crests as “plateaus”. This may be advantageous if the dimensional tolerances (in particular in relation to the thickness of the coating) are very narrow and/or the actual contact or fastening face is intended to have an exactly defined size.

According to one embodiment, a distance between two adjacent crests is about 2 to 8 mm. According to a preferred embodiment, the distance is about 4 to 6 mm. Here, the centers of two “corrugations” lying next to one another serve as reference points.

According to one embodiment, the coating has multiple tracks which are oriented parallel to one another and are oriented in a second direction, said second direction being perpendicular or substantially perpendicular to the first direction.

According to a preferred embodiment, the thermal spraying method is in particular a cold gas spraying method. Often, the tracks generated during the thermal spraying typically have approximately a circular segment shape in cross section. The top of these circular segments forms, for example, a crest. If multiple tracks are then generated at a distance next to one another, there is correspondingly a succession of crests and troughs.

According to a preferred embodiment, a thickness of the coating is about 0.1 to 0.3 mm. In particular, according to a preferred embodiment, a crest is, as it were, in particular 1 to 3 mm high. Correspondingly, a “height” or thickness of the troughs is about 0.15 to 0.25 mm according to preferred embodiments.

It is entirely possible that, depending on the selected nozzle during the thermal spraying, tracks can be generated which have a different geometry. However, it is also crucial here that in the first direction a surface is generated which is not smooth or at least not completely smooth, but rather has a corrugation.

According to a preferred embodiment, the average roughness depth Rz of the surface of the coating in the second direction is about 50 to 350 μm. According to a preferred embodiment, the roughness is 75 to 200 μm, particularly preferably 90 to 130 μm.

What is also important in this context is the particle size of the powder used during the thermal spraying, in particular during the cold gas spraying, which in the present case is preferably between 10 μm and 60 μm.

According to a preferred embodiment, the reversal points of the tracks do not lie on the fastening face. The fastening face correspondingly preferably has only tracks which are oriented parallel to one another and extend in the second direction.

According to a preferred embodiment, the coating material comprises a steel material, in particular a stainless steel, particularly preferably an austenitic stainless steel such as 316L. 316L (also known as alloy 1.4404) is an austenitic, high-grade steel which, owing to its high chromium and molybdenum content in conjunction with a low carbon content, has a very good corrosion resistance.

According to one embodiment, the coating material comprises a material which has a higher electrical conductivity than steel. According to a preferred embodiment, the coating material comprises, for example, copper. Correspondingly, an adhesion layer can advantageously be generated which additionally has a good to very good electrical conductivity. Components which are used for example as current connectors or the like, such as cell connectors, cable rails, etc., can thus also be correspondingly coated.

The invention is also directed to a method for producing a component with a coating, comprising the steps of:
providing a component;
regionally coating the component by a thermal spraying method in such a way that a coating is generated which has a corrugation in a first direction.

This corrugation is for example generated by the spraying on of multiple tracks oriented parallel to one another. As already mentioned, the thermal spraying method is preferably a cold gas spraying method. The advantages and features mentioned in connection with the component also apply analogously and correspondingly to the method, and vice versa.

According to a preferred embodiment, a gas pressure of between 40 and 60 bar and a gas temperature of between 90° and 1200° C. is used during the cold gas spraying. It was possible to achieve the best results particularly at a pressure of between 45 and 50 bar, in particular 47 bar, and a gas temperature of between 1000 and 1100° C., in particular 1050° C.

According to a preferred embodiment, the method comprises the step of: using a powder with a particle size of between 10 μm and 60 μm, particularly preferably of between 20 μm and 53 μm.

As already mentioned, materials used are preferably steel materials, such as in particular the aforementioned stainless steel material. This base material may, for example, also be mixed with a material in order to influence, in particular to increase, the electrical conductivity of the coating, such as copper. The use of electrically conductive powder (e.g. copper) makes it possible to obtain an electrically conductive screw connection including increased friction.

Further advantages and features will be apparent from the description below of an embodiment of a component with reference to the attached figures.

### BRIEF DESCRIPTION OF THE DRAWINGS

FIG. 1 is a schematic partial view of a fastening face of a component; and

FIG. 2 is a sectional view, as depicted in FIG. 1.

### DETAILED DESCRIPTION OF THE DRAWINGS

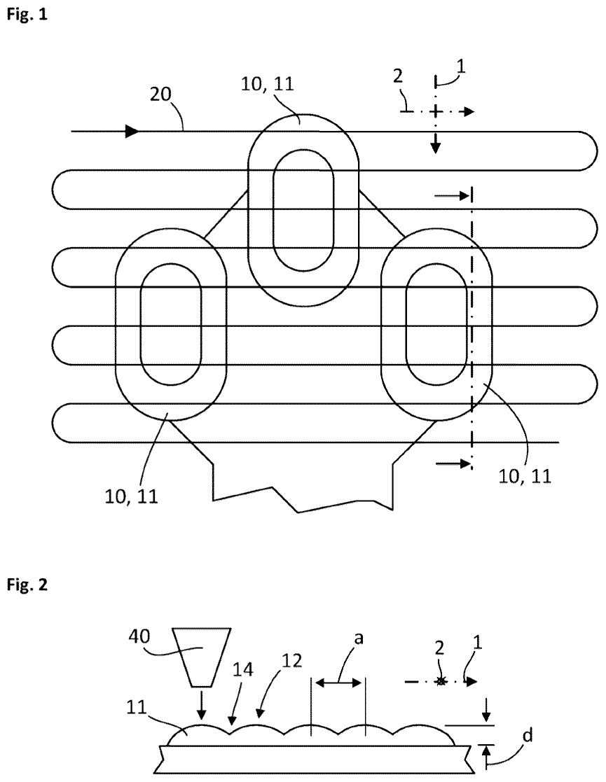

FIG. 1 schematically shows a partial view of a component comprising multiple fastening faces 10 on which coatings 11 are formed. In the present case, the fastening faces 10 are formed as faces which each have elongate holes provided for the screw-connection of the component. The fastening faces 10 can correspondingly also be referred to as screw-connection faces. The underlying component is, for example, a cast component, for example composed of an aluminum material. Reference designation 20 denotes multiple tracks along which a coating is applied for example by means of a thermal coating method, such as cold gas spraying.

According to a preferred embodiment, a robot is for example used to apply the coating. It can be seen that the reversal points of the tracks 20 each lie outside the fastening faces 10. Tracks 20 which are oriented parallel to one another and extend in a second direction are thus produced on the fastening faces 10. In a first direction 1, this coating application produces a corrugated profile, as depicted in FIG. 2; cf. In this respect also the section indicated in FIG. 1.

FIG. 2 shows the section indicated in FIG. 1, it being possible to see in particular the corrugated profile of the coating 11. In the first direction 1, there is a succession of crests 12 and troughs 14. A height (d) of the coating 11, that is to say in particular a height of the crests 12, is for example about 0.1 to 0.3 mm. A preferred distance (a) between two crests 12 lying next to one another is for example 2 to 8 mm. The reference designation 40 denotes a coating tool, such as a nozzle, by means of which the coating 11 is applied.

### LIST OF REFERENCE DESIGNATIONS

1 First direction
2 Second direction
10 Fastening face
11 Coating
12 Crest
14 Trough
20 Track
40 Coating tool, nozzle
a Distance
d Thickness, height

1.-12. (canceled)

13. A component, comprising:
a fastening region of the component having a fastening face which has a coating, wherein
the coating is a thermal spray/coating, and
the coating has a corrugated shape in a first direction.

14. The component according to claim 13, wherein
the corrugated shape is formed by a succession of troughs and crests, and
a distance between two adjacent crests is about 2 to 8 mm.

15. The component according to claim 13, wherein
the coating has multiple tracks which are oriented parallel to one another and are oriented in a second direction which is perpendicular to the first direction.

16. The component according to claim 13, wherein a thickness of the coating is about 0.1 to 0.3 mm.

17. The component according to claim 15, wherein an average roughness depth of a surface of the coating in the second direction is about 50 to 350 μm.

18. The component according to claim 15, wherein reversal points of the multiple tracks do not lie on the fastening face.

19. The component according to claim 13, wherein a material of the coating comprises steel.

20. The component according to claim 13, wherein a material of the coating comprises copper.

21. The component according to claim 13, wherein the fastening face is a screw-connection face.

22. A method for producing a component with a coating, the method comprising the steps of:
providing a component;
regionally coating the component by a thermal spraying method such that the coating is generated to have a corrugation in a first direction.

23. The method according to claim 22,
wherein the coating method is cold gas spraying, and
wherein spraying is effected at a gas pressure of between 40 bar and 60 bar and a gas temperature of between 900° C. and 1200° C.

24. The method according to claim 22, further comprising the step of:
using a powder with a particle size of between 12 μm and 60 μm for the coating.
